(19) United States
(12) Patent Application Publication
(10) Pub. No.: US 2010/0017081 A1
(43) Pub. Date: Jan. 21, 2010

(54) METHOD FOR CONTROLLING A CONTINUOUSLY VARIABLE AUTOMATIC TRANSMISSION FOR A MOTOR VEHICLE

(75) Inventor: Julien Maynard, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne Billancourt (FR)

(21) Appl. No.: 12/519,641

(22) PCT Filed: Oct. 17, 2007
(86) PCT No.: PCT/FR2007/052179

§ 371 Date: Aug. 19, 2009

(30) Foreign Application Priority Data
Dec. 18, 2006 (FR) 0611013

(51) Int. Cl. G06F 19/00

(52) U.S. Cl. 701/58

(57) ABSTRACT

A method for controlling a continuously variable automatic transmission for a motor vehicle, equipped with a forced downshift device known as a kick down implemented by the driver fully depressing the accelerator pedal to obtain the vehicle's maximum acceleration, and with an electronic engine management system. The method determines the engine speed at which maximum engine power can be obtained, as a function of an operating state of the engine and of components connected to the engine, for example a particle filter, and as a function of environmental conditions outside the vehicle, for example the altitude during kick down procedures.

The invention relates to a method of controlling a continuously variable automatic transmission for a motor vehicle, particularly during forced downshifts, often known in English as “kick downs”, in order rapidly to obtain a great deal of vehicle acceleration.

A downshift such as this is initiated by deliberate action on the part of the driver on the throttle pedal which he fully depresses in order to obtain a great deal of acceleration of his vehicle, which is interpreted by the vehicle power plant management system as a demand for maximum power. This may be needed, for example, during overtaking (passing) or in an emergency situation. The method of controlling the continuously variable automatic transmission will set the engine speed to the value corresponding to its maximum power.

The technical problem presented by these “kick down” procedures is that the engine speed that will allow maximum power to be obtained changes under various conditions, including the environmental driving conditions, the operating state of the engine or other conditions. Thus, atmospheric conditions, such as the altitude, modify engine performance, and in particular, the density of the air, which decreases with altitude, has the effect of limiting said performance and in some cases of lowering the maximum-power speed.

As far as engine operation is concerned, the use of a particulate filter, by increasing the exhaust back pressure, alters the maximum performance of the engine and is likewise liable to lower this maximum-power speed when soiled. Likewise, if the engine is being operated in degraded mode, with deliberate limits on performance, this too has the effect of lowering the maximum-power speed of the engine.

A continuously variable automatic transmission, replacing the traditional mechanical gearbox, is generally made up of two variable-diameter pulleys connected by a belt. The first pulley, known as the primary or drive pulley, is driven by the engine and the second pulley, known as the secondary pulley, is connected to the driven wheels of the vehicle. To alter the step-down ratio to suit the requirements determined notably by the position of the throttle pedal, the diameter of the primary pulley and of the secondary pulley is varied.

The benefit of an automatic transmission such as this lies in its control that can precisely position the engine speed at the maximum-power point, in the event of a demand for maximum acceleration through “kick down” on the part of the driver, but the disadvantage of a transmission such as this produced in the present form is that it does not take into consideration any shortfall in engine power that may appear in certain circumstances mentioned hereinabove. In such cases, the driver may obtain a power, and therefore an acceleration of his vehicle, that is inferior to that which he had available before his “kick down” request.

At the present time, in the case of an n-speed automatic transmission, the altitude at which the vehicle is driving is taken into consideration by estimation, then the control laws are shifted to incorporate the engine power shortfall, as described in American U.S. Pat. No. 4,943,921. That invention, which applies only to n-speed automatic gearboxes, considers the altitude only for the purposes of assessing the power shortfall, and does not in any way consider the soiling of the particulate filter or use in degraded modes. In addition, that invention merely shifts the gearshift laws to suit the atmospheric pressure and does not work on engine speed setpoints.

It is an object of the invention to take the engine power shortfall into consideration at the time of demands for great acceleration through “kick down” procedures in order to obtain the maximum power actually provided by the engine. To this end, the method of controlling the continuously variable automatic transmission takes account of the operating state of the engine and of the vehicle environmental conditions.

To do that, a subject of the invention is a method of controlling a continuously variable automatic transmission for a motor vehicle, equipped with a forced downshift device, otherwise known as a “kick down” device, operated by the driver completely depressing the throttle pedal in order to obtain the maximum acceleration of the vehicle, and with an electronic engine management system, characterized in that it determines the engine speed at which maximum engine power can be achieved, as a function of the operating state of the engine and of the components associated therewith, particularly a particulate filter, and of the environmental conditions outside the vehicle, particularly the altitude, during forced downshift procedures.

According to another feature of the method, it comprises the following steps:
detecting a demand for maximum acceleration through a “kick down” procedure initiated through a deliberate action on the part of the driver,
determining the engine speed at which maximum engine power can be achieved as a function of the operating state of the engine and of the vehicle environment,
calculating the automatic transmission primary speed setpoint to be applied to said automatic transmission in order to obtain maximum engine power, if a demand for maximum acceleration has been detected.

According to another feature of the control method, if no demand for maximum acceleration through a “kick down” procedure has been detected, the speed setpoint is the nominal value calculated as a function of the environment and of the actions of the driver, for the automatic transmission control mode initiated without the detection of such a “kick down” procedure.

According to another feature of the control method, the step of detecting the demand for “kick down” is performed by processing the information on the extent to which the throttle pedal has been depressed, this information being delivered, for example, by the engine management system.

According to another feature of the control method, the state of the engine is defined by the degree of soiling of the particulate filter when such a filter is associated with the engine and by the degraded modes of operation thereof.

According to another feature of the control method, the environmental conditions for the vehicle are defined notably by the altitude.

According to another feature of the control method, the step of determining the engine speed at which maximum power can be achieved as a function of its state and of the vehicle environment, uses information about atmospheric pressure to determine the altitude, the exhaust pressure to evaluate the degree of soiling of the particulate filter with which the engine is equipped, and the outputs of the degraded modes of the engine.

Other features and advantages of the invention will become apparent from reading the description of the control method, which is illustrated by the attached figures which are:

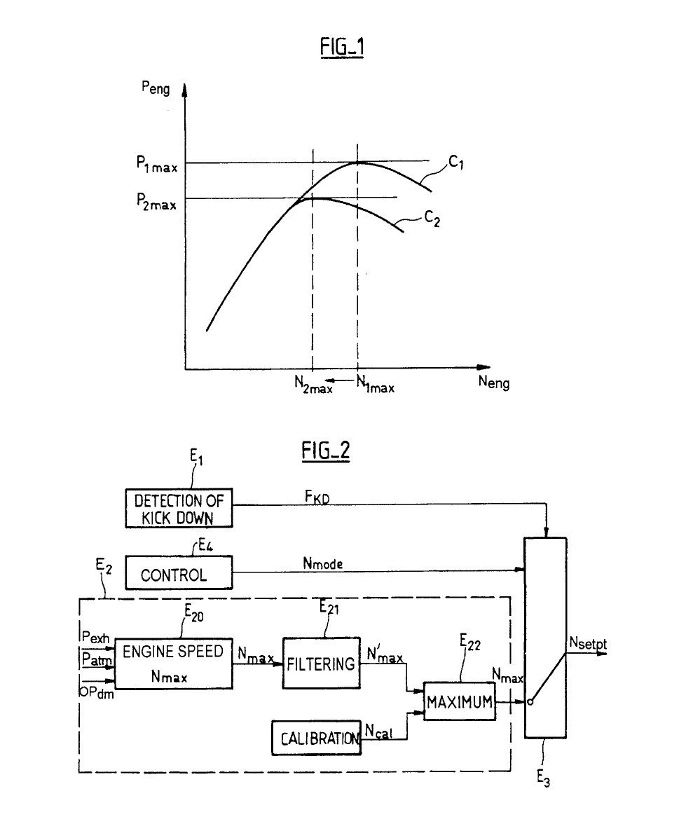

FIG. 1: the variations in engine power as a function of speed,

FIG. 2: the various steps in the control method according to the invention,

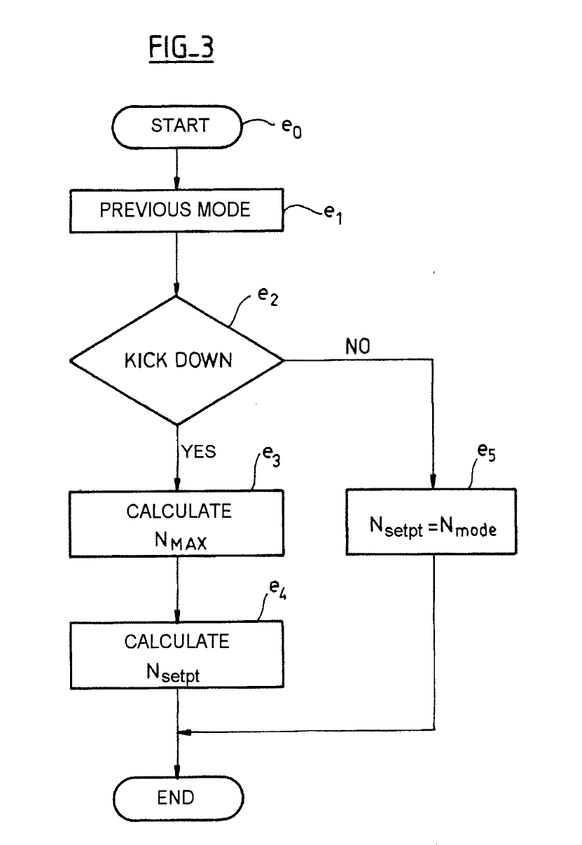

FIG. 3: the flow diagram of the method according to the invention.

The method of controlling a continuously variable automatic transmission delivers primary speed setpoints, the primary speed being equal to the engine speed when the clutch of the hydraulic torque converter is engaged and the transmission ratio selector is positioned in “drive”, that is to say in forward gear. Indeed, because the ratio of a transmission is the ratio between the primary speed and the secondary speed which is fixed by the speed of the vehicle, talking in terms of primary speed is the same as talking in terms of ratio. The control method is therefore intended to deliver an engine speed setpoint while the engine controls its torque.

These primary speed setpoints are set for various modes activation of which is dependent on the environment and driver actions, such as, for example, a sports mode, an economy mode, a downhill driving mode, a manual mode, etc., and the forced downshift mode known as “kick down”. These primary speed setpoints are calculated as a function of driver demands embodied in the form of actions on the throttle and brake pedals, sequential control in manual mode, amongst other things, and as a function of environmental variables such as the speed of the vehicle, detection of the gradient of the road on which the vehicle is driving, the temperature of the transmission, for example.

As shown in FIG. 1, under normal vehicle operating conditions at zero altitude and at an outside temperature of 20° C., with an engine the particulate filter of which is not sooted and which is not operating in degraded mode, the curve C₁ showing the variation in engine power P_{eng} as a function of engine speed N_{eng} shows that the power increases up to a maximum value P₁ₘₐₓ corresponding to an engine speed N₁ₘₐₓ before decreasing for higher speed values. In the case of different conditions that degrade engine power, the curve C₂ of the variation in this power has a maximum P₂ₘₐₓ lower than the maximum P₁ₘₐₓ of the curve C₁ and corresponding to a speed N₂ₘₐₓ likewise lower than the speed N₁ₘₐₓ that corresponds to the maximum power P₁ₘₐₓ of the curve C₁.

In the event of a demand for maximum acceleration through a “kick down” procedure, the engine speed has to vary from the value N₁ₘₐₓ to the value N₂ₘₐₓ because of the shortfall in performance, because if the speed N₁ₘₐₓ were maintained, the driver would lose out on power at the time of his demand for maximum acceleration, which he would not get.

The control method according to the invention adapts the engine speed in the event of a “kick down” procedure so that the engine delivers its actual maximum power under the instantaneous vehicle operating conditions. To do that, as FIG. 2 shows, it performs a first step E₁) of detecting the demand for maximum acceleration known as “kick down” by processing the information Iₚ regarding the extent to which the throttle pedal is depressed, this information being delivered, for example, by the engine management system.

When such a forced downshift procedure is detected, the method performs a step E₂) of determining the engine speed N_{MAX} at which maximum power can be achieved, as a function of the state of the engine and of the vehicle environment. To do this, it uses the information regarding atmospheric pressure Pₐₜₘ to determine the altitude, the exhaust pressure Pₑₓₕ to evaluate the level of soiling of the particulate filter and the outputs OP_{dm} of the degraded modes of the engine to calculate a first engine speed value Nₘₐₓ. In addition, in order that the maximum power primary speed should not fluctuate, this information Nₘₐₓ, established in step E₂₀), is filtered in a step E₂₁) to give a new value N′ₘₐₓ. Finally, it is possible to guarantee the driver a minimum engine speed regardless of the shortfall in torque. To do this, step E₂₂) establishes the maximum between N′ₘₐₓ, which is the output from the aforementioned filter, and N_{cal} which is an engine speed value set by calibration in a table dependent on vehicle speed.

If a procedure whereby the driver is demanding maximum acceleration through “kick down” is detected, the final primary speed setpoint in Nₛₑₜₚₜ is the value of the previously determined engine speed N_{MAX} corresponding to the speed at which maximum power can be achieved under the present conditions.

By contrast, if no “kick down” procedure is detected, the ratio setpoint is the nominal value N_{mode}, calculated in step E₄), as a function of the environment and of driver actions, for the automatic transmission control mode initiated without the detection of a “kick down” procedure.

This speed setpoint Nₛₑₜₚₜ is established in step E₃) as a function of the signal F_{KD} detecting a forced acceleration demand of the “kick down” type.

FIG. 3 is a flow diagram of the method of controlling a continuously variable automatic transmission. After the initialization step e₀), transmission control is performed in a mode determined by the driver, for example sports or economy mode, which is the subject of step e₁) and known as the previous mode. If, during a step e₂), a maximum acceleration procedure through “kick down” is detected, the method then comprises a step e₃) of determining the engine speed N_{MAX} to obtain the maximum power actually supplied by the engine, which is followed by a step e₄) of calculating the final primary speed setpoint Nₛₑₜₚₜ from the speed N_{MAX} calculated in step e₃).

If, on the other hand, there has been no detection of a “kick down” procedure in step e₂), the primary speed setpoint Nₛₑₜₚₜ delivered by the control system in step e₅) is the one N_{mode} determined and applied according to the mode chosen in step e₁).

Thus, by virtue of the invention, when a driver is going to undertake a forced downshift procedure known as “kick down”, he can be sure of obtaining the maximum power that the engine can provide given its state and the vehicle environment at the moment of this procedure because the power shortfall conditions have been taken into consideration.

1-9. (canceled)

10. A method of controlling a continuously variable automatic transmission for a motor vehicle, including a forced downshift device, operated by a driver completely depressing a throttle pedal to obtain maximum acceleration of the vehicle, and with an electronic engine management system, the method comprising:
determining engine speed at which maximum engine power can be achieved, as a function of an operating state of the engine and of components associated therewith, or of a particulate filter, and of environmental conditions outside the vehicle, or of altitude, during forced downshift procedures.

11. The control method as claimed in claim 10, further comprising:
e1) detecting a demand for maximum acceleration through a kick down procedure initiated through a deliberate action by the driver;
e2) determining the engine speed at which maximum power can be achieved as a function of the operating state of the engine and of the environmental conditions; and
e3) calculating the automatic transmission primary speed setpoint to be applied to the transmission obtain maximum engine power, if a demand for maximum acceleration has been detected.

12. The control method as claimed in claim 11, wherein, if no demand for maximum acceleration through a kick down procedure has been detected, the speed setpoint is the nominal value calculated as a function of the environmental conditions and of the actions of the driver, for the automatic transmission control mode initiated without detection of the kick down procedure.

13. The control method as claimed in claim 11, wherein the e1) detecting the demand for kick down is performed by processing information on an extent to which the throttle pedal has been depressed, this information being delivered by the engine management system.

14. The control method as claimed in claim 11, wherein the state of the engine is defined by a degree of soiling of a particulate filter associated with the engine and by degraded modes of operation of the particulate filter.

15. The control method as claimed in claim 11, wherein the environmental conditions for the vehicle are defined by altitude.

16. The control method as claimed in claim 14, wherein the e2) determining the engine speed corresponding to the maximum power actually provided by the engine, as a function of its state and of the environmental conditions, uses information about atmospheric pressure to determine altitude, exhaust pressure to evaluate degree of soiling of the particulate filter, and outputs degraded modes of the engine.

17. The control method as claimed in claim 16, wherein the e2) determining the engine speed at which maximum power can be achieved comprises filtering a first value established as a function of its state and of the environmental conditions, followed by guaranteeing the driver a minimal engine speed whatever the shortfall in torque.

18. The control method as claimed in claim 17, wherein the guaranteeing adopts the maximum between the filtered value and the engine speed value set by calibration in a table dependent on vehicle speed.
